(19) United States
(12) Patent Application Publication
(10) Pub. No.: US 2016/0342609 A1
(43) Pub. Date: Nov. 24, 2016

(54) SYSTEMS, METHODS, AND COMPUTER PROGRAM PRODUCTS PROVIDING AN ELASTIC SNAPSHOT REPOSITORY

(71) Applicant: NetApp, Inc., Sunnyvale, CA (US)

(72) Inventors: Mahmoud K. Jibbe, Wichita, KS (US); Charles Binford, Wichita, KS (US)

(21) Appl. No.: 14/719,008

(22) Filed: May 21, 2015

(51) Int. Cl. G06F 17/30; G06F 11/14

(52) U.S. Cl. CPC G06F 17/30088; G06F 11/1448; G06F 17/30117

(57) ABSTRACT

A system, method, and computer program product for the provision of an elastic snapshot repository is disclosed. A snapshot repository with a particular size stores snapshot images. As the used capacity of the snapshot repository exceeds a predetermined threshold, another volume is added from a pool of available volumes. When the used capacity of the snapshot repository is at, or falls below, a lower threshold, a second snapshot repository is created. The schedule associated with the first snapshot repository is transferred to the second snapshot repository. The snapshot images in the first snapshot repository remain available to meet a minimum history requirement. New snapshot images are stored to the second snapshot repository until there are enough snapshot images in the second snapshot repository, alone, to meet the minimum history requirement. The first snapshot repository is deleted in response and the associated volumes released to the pool.

### TECHNICAL FIELD

The present description relates to data storage and, more specifically, to systems, methods, and machine-readable media for the elastic growth and shrinking of a snapshot repository.

### BACKGROUND

In many data storage systems, data is periodically backed up so that the backed up data may be used in the event of a loss of data at the source. One such way to accomplish this is with copy-on-write snapshots. A snapshot may contain data that represents what occurred during a specified time frame, such as a portion of a day. When a write is directed to a block of a base volume, a copy-on-write snapshot copies the targeted block of data before the write occurs. The targeted block of data is copied and may be stored to another, separate volume (repository) for data recovery/rollback purposes. Once the targeted block is copied at the particular point in time, the write to the targeted block may then proceed and overwrite the targeted block with the new write data. Snapshots may be periodically taken indefinitely (e.g., over an indefinite number of periods). This leads to more and more snapshots being saved to the system's repository, which takes up more and more storage space in the repository.

Typically a system's repository for copy-on-write snapshots is limited in size, for example to a small percentage of each base volume for which snapshots are taken. A user of the system may impose a minimum snapshot history, a minimum number of snapshot images to be stored in the repository at any given time. The size may be set manually at the time of initialization of the repository, and expansion may only be achieved by manually adding another volume (range of logical block addresses (LBAs)) to the repository. Further, copy-on-write snapshot systems typically include an automatic purge feature that purges “older” snapshot images when large amounts of data in new snapshot images are added. In these scenarios, the snapshot repository may be at risk of either expanding to consume too much (or all) spare capacity or purging so many older snapshot images that the minimum snapshot history is no longer kept (e.g., where 5 images are required to be kept as history, and the system automatically purges 4 of the older ones to make room for an occasional surge in writes, such as a report that generates a large amount of data) or lost completely.

Accordingly, the potential remains for improvements that, for example, result in an elastic snapshot repository that may automatically grow within specified bounds and also shrink after occasional large-capacity demands come and go.

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2 is an organizational diagram that illustrates the growth of a snapshot repository according to aspects of the present disclosure.

FIG. 3 is an organizational diagram that illustrates the maintenance of a snapshot repository according to aspects of the present disclosure.

FIG. 4A is an organizational diagram that illustrates the shrinking of a snapshot repository according to aspects of the present disclosure.

FIG. 4B is an organizational diagram that illustrates the shrinking of a snapshot repository according to aspects of the present disclosure.

FIG. 4C is an organizational diagram that illustrates the shrinking of a snapshot repository according to aspects of the present disclosure.

FIG. 5 is a flow diagram of a method of providing an elastic snapshot repository according to aspects of the present disclosure.

FIG. 6 is a flow diagram of a method of growing and maintaining an elastic snapshot repository according to aspects of the present disclosure.

FIG. 7 is a flow diagram of a method of shrinking an elastic snapshot repository according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for the dynamic growing and shrinking of a snapshot repository. The techniques described herein enable a copy-on-write snapshot repository to dynamically grow and shrink the snapshot repository in response to varying levels of data writes during different time periods. In an example, a snapshot repository is started for a corresponding base volume with a particular size (e.g., a fixed size or a percentage of the corresponding base volume it is backing up). As snapshot images are created in the snapshot repository and grow over time in response to write activity to the base volume, the size of one or more snapshot images may be larger than anticipated or predicted. This may occur, for example, due to unique circumstances where more writes than anticipated are triggered, such as in response to a request to run a report that generates much more data than typically is the case. In response to the used capacity of the snapshot repository exceeding a predetermined threshold with respect to the overall capacity of the snapshot repository, one or more additional volumes may be added to the snapshot repository during operation. These additional volumes may be drawn from a pool of available, already-initialized volumes that have not been assigned elsewhere.

If certain conditions aren't met, however, at a time that the predetermined threshold triggers the possibility of growth of the snapshot repository, then the snapshot repository may be maintained at its current size without adding any additional, available volumes. For example, if there is a maximum number of volumes that any given snapshot repository may have, and the snapshot repository is at the limit, then the system would prevent the dynamic growth of the snapshot repository beyond that limit. Further, if a usage threshold is exceeded then the snapshot repository may not be grown. For example, the usage threshold may be a used capacity of the snapshot repository (or, alternatively, the overall capacity of the snapshot repository) being is greater than the total capacity of the available volumes. As another example, the usage threshold may be a minimum number of available volumes required to remain in the available pool at all times.

As new snapshot images are created at new points in time and added to in the snapshot repository, older images may begin to “age out” of the snapshot repository—become unnecessary due to new snapshot images meeting a minimum history requirement and, therefore, be deleted. The system may detect that the used capacity of the snapshot repository is at, or falls below, a lower threshold (e.g., used capacity versus overall capacity of the snapshot repository). This may trigger the system to create a second snapshot repository and begin creating images in and writing data to the second snapshot repository. As a result, new images are not written to the first snapshot repository, but the first snapshot repository remains available during a transition time so that the snapshot images in the first snapshot repository remain available to meet the minimum history requirements. New snapshot images are now created in the second snapshot repository. Once there are enough snapshot images in the second snapshot repository, alone, to meet the minimum history requirement, the system deletes the first snapshot repository and releases the volume(s) associated with the first (deleted) snapshot repository to the pool of available volumes. As a result, the snapshot repository may dynamically grow and shrink as the backup requirements for a given base volume varies over time.

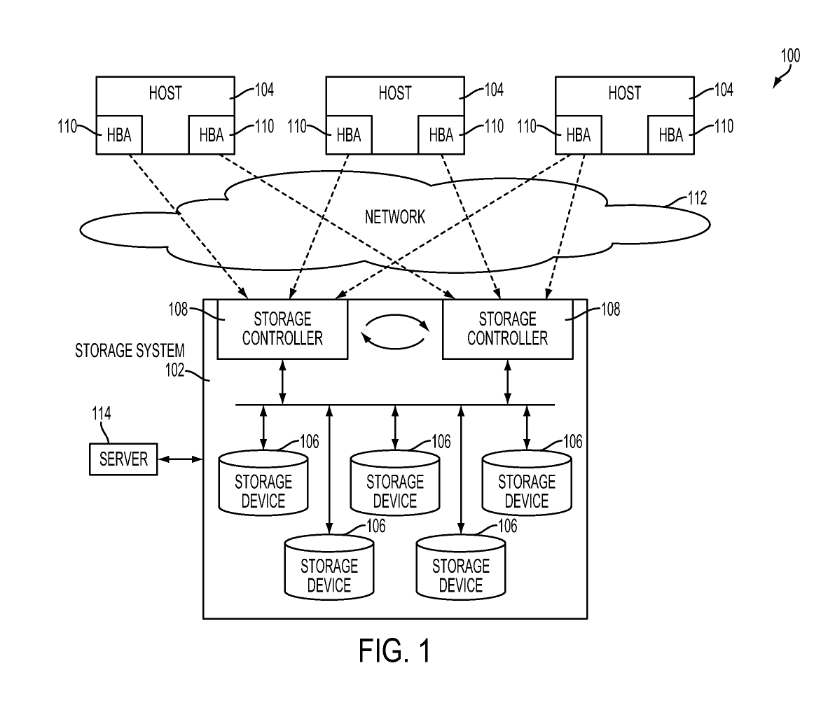

A data storage architecture 100 is described with reference to FIG. 1. The storage architecture 100 includes a storage system 102 in communication with a number of hosts 104. The storage system 102 is a system that processes data transactions on behalf of other computing systems including one or more hosts, exemplified by the hosts 104. The storage system 102 may receive data transactions (e.g., requests to read and/or write data) from one or more of the hosts 104, and take an action such as reading, writing, or otherwise accessing the requested data. For many exemplary transactions, the storage system 102 returns a response such as requested data and/or a status indictor to the requesting host 104. It is understood that for clarity and ease of explanation, only a single storage system 102 is illustrated, although any number of hosts 104 may be in communication with any number of storage systems 102.

While the storage system 102 and each of the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor such as a microcontroller or a central processing unit (CPU) operable to perform various computing instructions. The instructions may, when executed by the processor, cause the processor to perform various operations described herein with the storage controllers 108 in the storage system 102 in connection with embodiments of the present disclosure. Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 and responds to one or more hosts 104's data transactions so that the storage devices 106 appear to be directly connected (local) to the hosts 104. In various examples, the storage devices 106 include hard disk drives (HDDs), solid state drives (SSDs), optical drives, and/or any other suitable volatile or non-volatile data storage medium. In some embodiments, the storage devices 106 are relatively homogeneous (e.g., having the same manufacturer, model, and/or configuration). However, it is also common for the storage system 102 to include a heterogeneous set of storage devices 106 that includes storage devices of different media types from different manufacturers with notably different performance.

The storage system 102 may group the storage devices 106 for speed and/or redundancy using a virtualization technique such as RAID (Redundant Array of Independent/Inexpensive Disks). The storage system may also arrange the storage devices 106 hierarchically for improved performance by including a large pool of relatively slow storage devices and one or more caches (i.e., smaller memory pools typically utilizing faster storage media). Portions of the address space may be mapped to the cache so that transactions directed to mapped addresses can be serviced using the cache. Accordingly, the larger and slower memory pool is accessed less frequently and in the background. In an embodiment, a storage device includes HDDs, while an associated cache includes SSDs.

In an embodiment, the storage system 102 may group the storage devices 106 using a dynamic disk pool virtualization technique. In a dynamic disk pool, volume data, protection information, and spare capacity is distributed across each of the storage devices included in the pool. As a result, each of the storage devices in the dynamic disk pool remain active, and spare capacity on any given storage device is available to each of the volumes existing in the dynamic disk pool. Each storage device in the disk pool is logically divided up into one or more data extents at various logical block addresses (LBAs) of the storage device. A data extent is assigned to a particular data stripe of a volume. An assigned data extent becomes a “data piece,” and each data stripe has a plurality of data pieces, for example sufficient for a desired amount of storage capacity for the volume and a desired amount of redundancy. e.g. RAID 5 or RAID 6. As a result, each data stripe appears as a mini RAID volume, and each logical volume in the disk pool is typically composed of multiple data stripes.

The storage system 102 also includes one or more storage controllers 108 in communication with the storage devices 106 and any respective caches. The storage controllers 108 exercise low-level control over the storage devices 106 in order to execute (perform) data transactions on behalf of one or more of the hosts 104. The storage system 102 may also be communicatively coupled to a user display for displaying diagnostic information, application output, and/or other suitable data.

For example, the storage system 102 is communicatively coupled to server 114. The server 114 includes at least one computing system, which in turn includes a processor, for example as discussed above. The computing system may also include a memory device such as one or more of those discussed above, a video controller, a network interface, and/or a user I/O interface coupled to one or more user I/O devices. While the server 114 is referred to as a singular entity, the server 114 may include any number of computing devices and may range from a single computing system to a system cluster of any size.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with a storage controller 108 of the storage system 102. The HBA 110 provides an interface for communicating with the storage controller 108, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. The HBAs 110 of the hosts 104 may be coupled to the storage system 102 by a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), the Internet, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., read, write, modify, etc.) remote data, a host HBA 110 sends one or more data transactions to the storage system 102. Data transactions are requests to read, write, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The storage system 102 executes the data transactions on behalf of the hosts 104 by reading, writing, or otherwise accessing data on the relevant storage devices 106. A storage system 102 may also execute data transactions based on applications running on the storage system 102 using the storage devices 106. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a Wide Area Network (WAN), and/or a Local Area Network (LAN). Fibre Channel and FCoE are well suited for embodiments where hosts 104 are coupled to the storage system 102 via a direct connection or via Fibre Channel switches. A Storage Attached Network (SAN) device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. It is understood that the scope of present disclosure is not limited to either block-level or file-level protocols, and in many embodiments, the storage system 102 is responsive to a number of different memory transaction protocols.

In an embodiment, the server 114 may also provide data transactions to the storage system 102. Further, the server 114 may be used to configure various aspects of the storage system 102, for example under the direction and input of a user. Some configuration aspects may include definition of RAID group(s), disk pool(s), and volume(s), to name just a few examples. In an embodiment, the server 114 may store instructions, for example in one or more memory devices. The instructions may, when executed by a processor for example in association with an application running at the server 114, cause the processor to perform the operations described herein to provide the configuration information to the storage controllers 108 in the storage system 102 in connection with embodiments of the present disclosure.

The server 114 may include a general purpose computer or a special purpose computer and may be embodied, for instance, as a commodity server running a storage operating system. The server includes at least one processor which executes computer-readable instructions to perform the functions described herein.

The storage controller 108 (for example, one of the storage controllers 108 illustrated in FIG. 1) may receive a write command from one or more hosts 104 for a block of data to be written to a location within one of the storage devices 106 (e.g., to a logical address in a logical volume that maps to a physical address within a storage device 106). According to aspects of the present disclosure, the server 114 utilizes the storage system 102 to implement a copy-on-write snapshot backup regime. The backup regime may be with respect to data stored at the server 114 or alternatively to data stored on behalf of the server 114 and/or one or more hosts 104 at the storage system 102. Upon receipt of the write command the storage controller 108 may first back up the block of data of the storage device 106 (or other storage device where the data to be overwritten is located) that corresponds to the write command's target (prior to the write occurring) by taking a snapshot of the data block. The storage controller 108 may add the snapshot to a snapshot image in a snapshot repository.

In an embodiment, the snapshot repository may comprise a concat logical volume corresponding to one or more supporting storage devices 106 (e.g., one or more RAID volumes). In other words, the storage controller 108 stores the snapshots to one or more storage drives 106 in the storage system 102 that have been logically arranged into a snapshot repository. In an embodiment, the snapshot repository may be associated with a particular base volume (whether local to the storage system 102 or located elsewhere). Any given base volume may have multiple snapshot repositories associated with it. In another embodiment, a given snapshot repository may have one or more base volumes associated with it.

In an embodiment, the server 114 includes a script that interacts with the storage system 102 to determine whether the snapshot repository should dynamically grow or shrink according to variations in writes to the corresponding base volume(s) over time. In an alternative embodiment, the script may be included with one or both of the storage controllers 108 of the storage system 102 itself (e.g., in embodiments where one or both storage controllers 108 implement a virtual machine at the storage system 102). For purposes of simplicity of discussion, the following will reference the script with respect to the server 114, although it will be recognized that this is exemplary only.

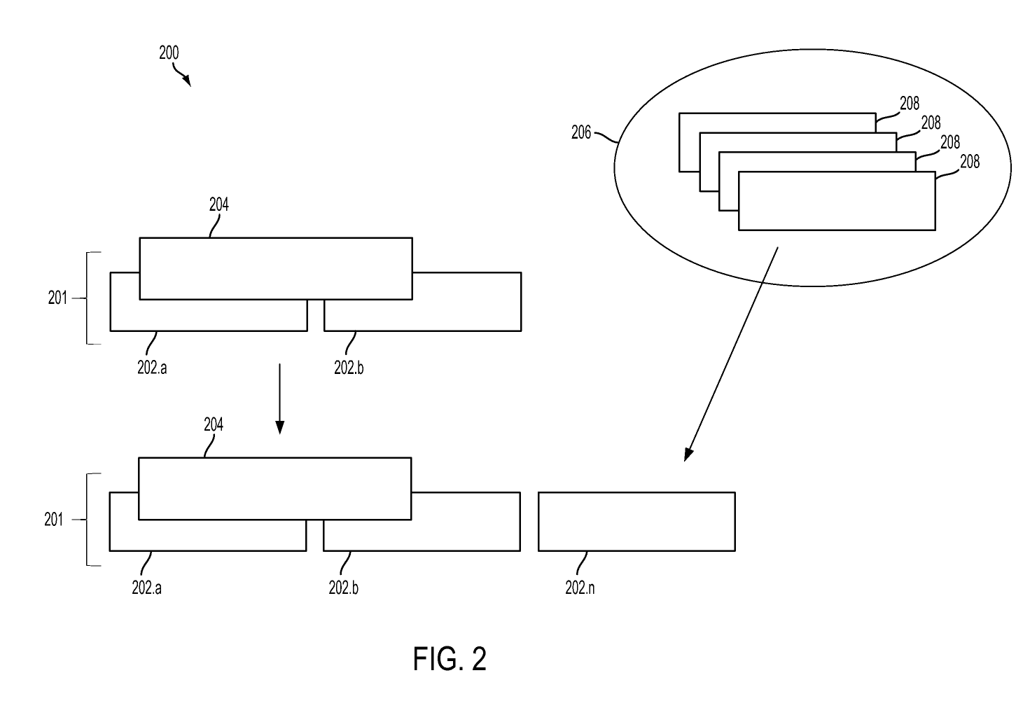

When the snapshot image is created in the corresponding snapshot repository in the storage system 102, the server 114 obtains information about the amount of used capacity in the snapshot repository with respect to the total size of the snapshot repository. This may occur, for example, by the script at the server 114 generating a command-line interface (CLI) command that queries the storage system 102 for a status of used capacity for the snapshot repository. The server 114 may request this information on an ad-hoc basis, according to a predetermined schedule, or the information may be reported as a matter of course during the operations without specific request. This is illustrated, for example, in FIG. 2 which is an organizational diagram that illustrates the growth of a snapshot repository according to aspects of the present disclosure.

As shown in FIG. 2, the snapshot repository 201 includes one or more volumes 202, with one or more snapshot images 204, and a pool 206 of available, pre-initialized volumes 208. The pre-initialized volumes 208 in the pool 206 may be volumes of equal size or, alternatively, of varying size as will be recognized. The snapshot repository 201 may be comprised of a concat logical volume which contains one or more RAID volumes as members (e.g., volumes 202.a and 202.b in FIG. 2). The concat logical volume presents the one or more member RAID volumes as one contiguous address space to the snapshot repository 201.

As shown in FIG. 2, the snapshot repository 201 includes volumes 202.a and 202.b (that, together, are storing a large snapshot image 204. The storage space which the large snapshot image 204 occupies, also referred to herein as used capacity of the snapshot repository, exceeds a pre-determined threshold amount of the overall amount of space available in the snapshot repository 201. In an embodiment, the threshold may be a storage size value, while in another embodiment the threshold may be an upper threshold percentage (e.g., the ratio of used capacity over the total capacity available in the snapshot repository 201 at that point in time).

The server 114, again by way of one or more processors, may determine that the used capacity exceeds the upper threshold. The server 114 may make this determination by comparing the reported used capacity to a pre-determined threshold, as discussed in more detail below. In response, the server 114 may issue a request that another volume 208 from the pool 206 be added to the snapshot repository 201 in order to dynamically grow the snapshot repository 201 during operation. Each volume 208 in the pool 206 may be another RAID volume that has been pre-initialized. As illustrated in FIG. 2, a volume 208 is added as volume 202.n to the snapshot repository 201, for example to the end of the existing concat volume 202.b. In an embodiment, the volume 202.n assumes the next contiguous LBA to the range in the volume 202.b. Because the volume 208 was previously initialized and allocated for snapshot repository use (but not assigned to a particular snapshot repository), the number of input/output operations per second (IOps) is not lowered and/or latency increased (because the volumes do not have to be initialized at the time of request). Although illustrated as adding one additional volume, it will be recognized that a grow operation may add any number of available volumes 208 at a given time. The number of available volumes 208 added at a given grow operation may be, for example, according to a pre-set number of volumes per growth operation (e.g., one, two, etc.), or alternatively according to information of the speed at which the used capacity is increasing with respect to time (where, e.g., a faster growth may correspond with adding more than one volume at a time, etc.).

As a result, the server 114 is able to automatically grow the repository 201 without requiring a manual notification to, and subsequent manual changes from, a system administrator via an interface with the server 114. This may be useful, for example, for dynamically responding to occasional “spikes” that may occur when a relatively large operation is performed by a host 104 (or server 114) that generates an excessive amount of data that causes writes that touch a large portion of the base volume's capacity.

Over time, as additional snapshot images are recorded in the storage system 102's snapshot repository, according to embodiments of the present disclosure the server 114 may instruct the storage controller 108 to dynamically grow the size of a snapshot repository until the snapshot repository utilizes a large portion of the total available logical volumes from a pool, such as the volumes 208 in pool 206 of FIG. 2 above. To prevent the system from automatically growing any particular snapshot repository so that the entire array of available drives and/or volumes are not taken, according to embodiments of the present disclosure the script executed by the processor(s) of the server 114 may impose a usage threshold. This may assume the form of the script at the server 114 preventing any requests to grow the repository in response to the storage system 102 reporting that the used capacity of the snapshot repository already meets the usage threshold. The threshold may assume various forms, such as imposing a limitation on a minimum number of available volumes 208 that should remain in the pool 206 or a percentage of used capacity in a given snapshot repository versus the total available space in the pool 206 of available repository volumes 208.

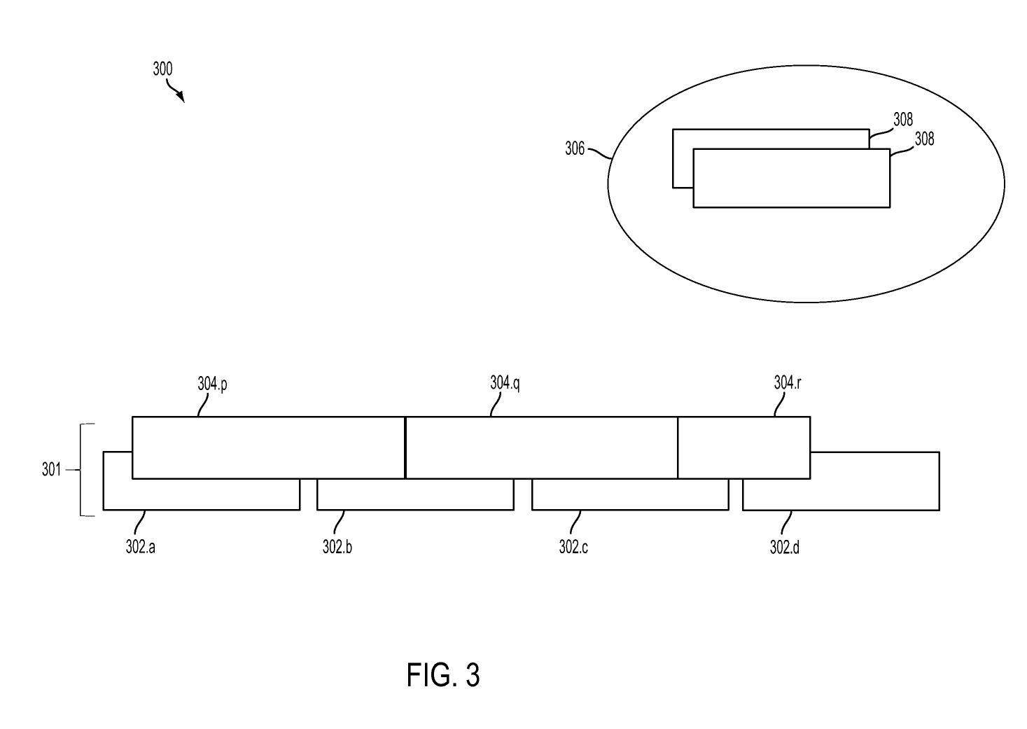

This is illustrated in the example of FIG. 3, which is an organizational diagram that shows the maintenance of a snapshot repository 301 according to aspects of the present disclosure. As illustrated in FIG. 3, the snapshot repository 301 has stored snapshot images 304.p, 304.q, and 304.r in the underlying volumes 302.a, 302.b, 302.c, and 302.d. As will be recognized, the number of volumes (in the snapshot repository 301 or in the pool 306), as well as the number of snapshot images in a given snapshot repository, are shown for illustration only; the actual number in any given situation may be more or less than that illustrated in these figures.

In FIG. 3, the used capacity of the snapshot repository 301 has again exceeded a pre-determined threshold amount of the overall amount of space available in the snapshot repository 301 (for example, in addition to the growth already described above with respect to FIG. 2). Prior to dynamically adding another available volume 308 from the pool 306, however, the server 114 may first determine whether a usage threshold has either been met or would be exceeded with the addition of another volume 308 to the snapshot repository 301. The script at the server 114 may generate a CLI command that again queries the storage system 102 for a status of used capacity for the snapshot repository 301. Based on the response that includes the reported used capacity, the server 114 may determine that the remaining number of volumes 308 in the pool 306 is below a minimum number required to remain available. In an embodiment, at least one available volume 308 is maintained in the pool 306 so that capacity deadlock is avoided during the shrinking process described in more detail below with respect to subsequent figures. Alternatively, the server 114 may determine that the used capacity of the snapshot repository 301 already meets or exceeds a percentage versus the total available space of the volumes originally allocated to the pool 306 (or currently still existing in the pool 306).

In response to this determination, the server 114 determines not to request further growth of the snapshot repository 301, but rather maintain the snapshot repository 301 at its current size. In this way, the allocation of all of the capacity of the entire array to the current needs of any given snapshot repository, such as snapshot repository 301, is prevented.

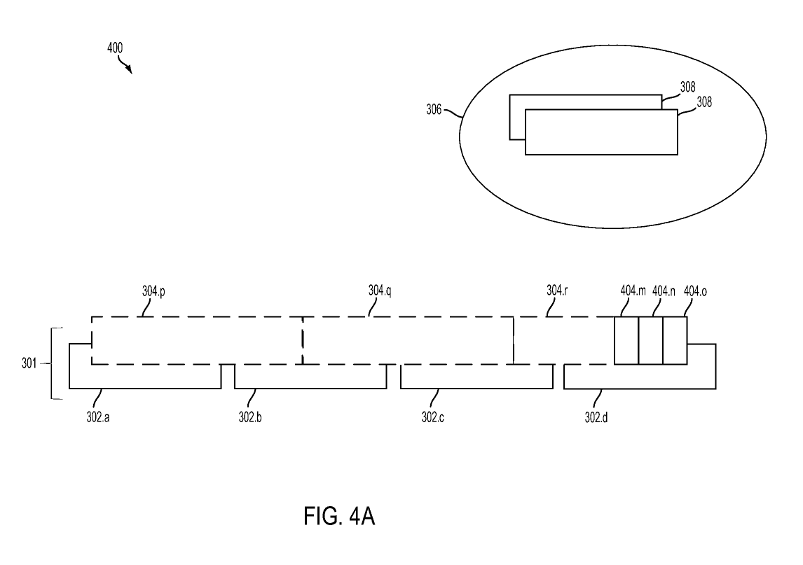

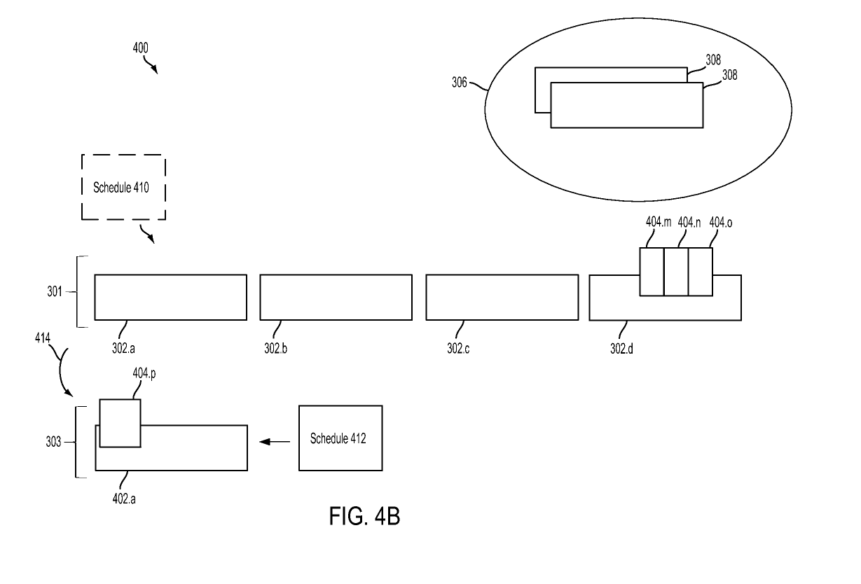

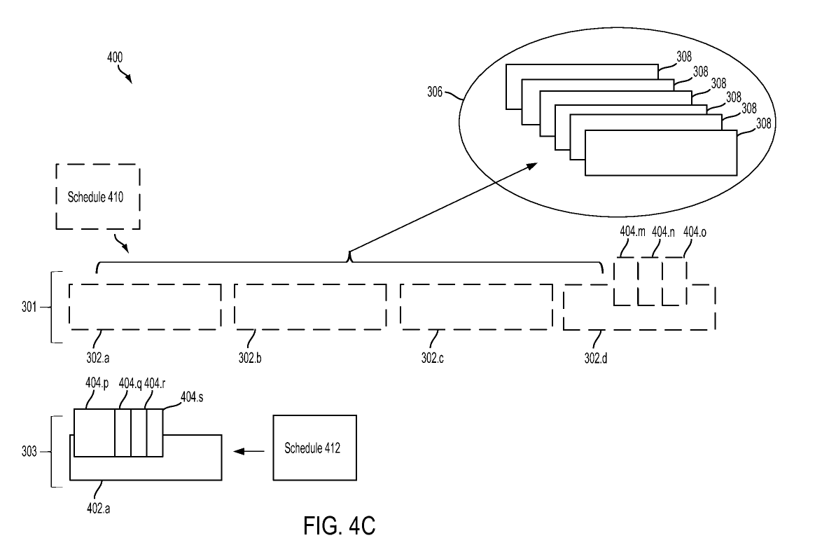

As time progresses, the snapshot images 304 in the snapshot repository 301 start “aging out” from the snapshot repository 301. The snapshot repository 301 may be set up with a minimum number of snapshot images 304 to maintain, for example three as illustrated in FIGS. 3 and 4. When additional snapshot images 304 are subsequently made/stored in the snapshot repository 301, the oldest snapshot images (e.g., older than the most recent three in this example) “age out” and may be deleted from the snapshot repository 301. This process may be directly controlled by the script at the server 114 or, alternatively, be delegated to the storage controller 108. This allows the snapshot repository 301 to be able to meet a user's estimated/required backup needs while still allowing the snapshot repository to remain within a reasonable size with respect to the overall capacity of the storage system 102.

This is illustrated in FIG. 4A, which shows an organizational diagram that illustrates the shrinking of a snapshot repository 301 according to aspects of the present disclosure. As shown in FIG. 4A, snapshot images 304.p, 304.q, and 304.r have “aged out” as now snapshot images 404.m, 404.n, and 404.o have been most recently stored in the snapshot repository 301. Although shown as all aging out together, it will be recognized that each may age out sequentially in time as each additional snapshot image is added, or in groups without departing from the scope of the present disclosure.

When the snapshot images 304.p, 304.q, and 304.r “age out,” the storage controller 108 deletes the images from the snapshot repository 301 (or the server 114 instructs the storage controller 108 to delete the images). As a result, the snapshot repository 301 now remains with excess capacity. This may occur, for example, due to the snapshot images 304.p, 304.q, and 304.r corresponding to periods in time where larger amounts of data were written to the base volume than otherwise occurs. Snapshot images 404.m, 404.n, and 404.o may represent points in time in which smaller amounts of data were written to the base volume in accordance with a more average or otherwise predicted usage. The snapshot images 404.m, 404.n, and 404.o are each significantly smaller than the snapshot images 304.p, 304.q, and 304.r, leaving a large amount of underlying capacity free but unavailable for other uses (such as other snapshot repositories). For example, as illustrated in FIG. 4A the volumes 302.a, 302.b, and 302.c become free after deletion of the aged-out snapshot images 304.p, 304.q, and 304.r.

It therefore becomes desirable to also be able to dynamically (and automatically) shrink the snapshot repository 301 to free up the underlying (now-available) volumes 302 to the pool 306 for other snapshot repositories' needs. However, current solutions do not allow the shrinking of a snapshot repository that has active snapshot images. Embodiments of the present disclosure address these limitations as illustrated in FIGS. 4B and 4C, described further below.

Turning now to FIG. 4B, an organizational diagram is illustrated that shows the shrinking of a snapshot repository 301 according to aspects of the present disclosure. FIG. 4B may illustrate, for example, what may occur after the events of FIG. 4A where one or more snapshot images “'age out” and are deleted from the snapshot repository 301.

To address the restriction that a snapshot repository with active snapshot images cannot be shrunk, while still maintaining any imposed requirement for a minimum number of snapshot images in history, a new snapshot repository 303 may be formed 414 and stacked with the snapshot repository 301. According to embodiments of the present disclosure, the script at the server 114 may instruct the storage controller 108 to create the new snapshot repository 303 after first determining that the used capacity of the snapshot repository 301 has fallen below a lower threshold amount with respect to the total capacity of the snapshot repository 301. This lower threshold amount may be a percentage of the used capacity with respect to the total capacity of the snapshot repository or, alternatively, a minimum number of volumes storing active snapshot images 404. Thus, in response to detecting that the used capacity has dipped below the threshold, the new snapshot repository 303 may be created.

As illustrated in FIG. 4B, each snapshot repository 301, 303 may have a corresponding schedule 410 and 412, respectively, associated therewith. The schedule 410 or 412 may be used to control the frequency at which the storage controller 108 stops a current snapshot image and starts a new snapshot image (e.g., a set number of hours, days, etc. that may be asynchronous to what is occurring with any corresponding hosts) for storage in a snapshot repository. In alternative embodiments, the snapshot repositories may not have schedules associated with them, but rather use other mechanisms to track what snapshot repository is currently active for a given base volume. For example, instead of a schedule a naming convention may be used to identify the current (active) snapshot repository to which to write. This may involve including a timestamp/date in the name of each snapshot repository, so that the system may identify the current snapshot repository based on the snapshot repository with the most recent timestamp/date as part of its name.

The following discussion will focus on embodiments that utilize the schedules, though it will be recognized that the description may be similarly applicable to other embodiments that utilize some equivalent to a schedule. In an embodiment, the schedules 410 or 412 may be maintained at the storage system 102, while in another embodiment the schedules may be maintained at the server 114. At any given point in time, just one schedule may be active for a given base volume (e.g., there may be multiple base volumes with associated schedules, and therefore multiple snapshot repositories growing and shrinking, concurrently). As a result, when the new snapshot repository 303 is created, the schedule 412 may become the active schedule and the schedule 410 associated with the snapshot repository 301 may be inactivated (or deleted). As a result, the snapshot repository 301 stops storing new snapshot images and, instead, the snapshot repository 303 begins storing subsequent snapshot images 404 in its place.

To maintain the minimum number of prior snapshot images 404 in the snapshot history, the snapshot repository 301 is not immediately deleted when the new snapshot repository 303 is created and enters use. Instead, the snapshot images 404 stored with the snapshot repository 301 remain available to meet the minimum history requirement set by the user. Thus, as shown in FIG. 4B the snapshot images 404.m, 404.n, and 404.o remain available as the new and most recent snapshot image 404.p is stored in the new snapshot repository 303. As new snapshot images are added to the new snapshot repository 303, the storage controller 108 (and/or server 114) may continue to “age out” images in the old snapshot repository 301 (as described above) or, alternatively, may let the images in the old snapshot repository 301 alone after the associated schedule 410 becomes inactive.

As time progresses, more snapshot images 404 may be added to the new snapshot repository 303 according to the schedule 412. This is illustrated in FIG. 4C, which shows an organizational diagram that illustrates the shrinking of a snapshot repository according to aspects of the present disclosure. As illustrated in FIG. 4C, over time the snapshot repository 303 stores additional snapshot images 404.q, 404.r, and 404.s. With the storage of these additional snapshot images, the minimum history requirement can now be met solely by the snapshot images 404 stored in the snapshot repository 303. As a result, the storage controller 108 deletes the snapshot repository 301 completely (e.g., according to a CLI command received from the server 114 or on its own accord). This deletion of snapshot repository 301 frees up the underlying volumes that had previously been associated with the snapshot repository 301 (illustrated as volumes 302.a, 302.b, 302.c, and 302.d in these figures for purposes of demonstration only). The volumes thus freed up may be added as available volumes 308 to the pool 306. These volumes may then be used to dynamically grow the snapshot repository 303, and/or any other snapshot repositories associated with the same or other base volumes, according to the features described above with respect to FIG. 2 and with respect to additional figures below.

As a result, according to embodiments of the present disclosure a copy-on-write snapshot repository may dynamically, and automatically, grow and shrink (from the perspective of the base volume and/or host) to address the varying demands of a system over time without taking all available storage capacity as well as preventing higher latency and/or lower IOps (as a result of the available volumes being previously initialized). As will be recognized, although the figures in the present disclosure illustrate the growth of a snapshot repository first (before shrinking of the snapshot repository), it is within the scope of the present disclosure that a snapshot repository may be initialized with a given size, and after the minimum number of images is met the server 114 may determine that the size of the snapshot repository as originally set is too large. As a result, the server 114 may undertake to shrink the repository as described above, prior to any automatic growth of the snapshot repository. Further, after shrinking it will be recognized that the server 114 may subsequently automatically grow the snapshot repository in response to the conditions described above being met.

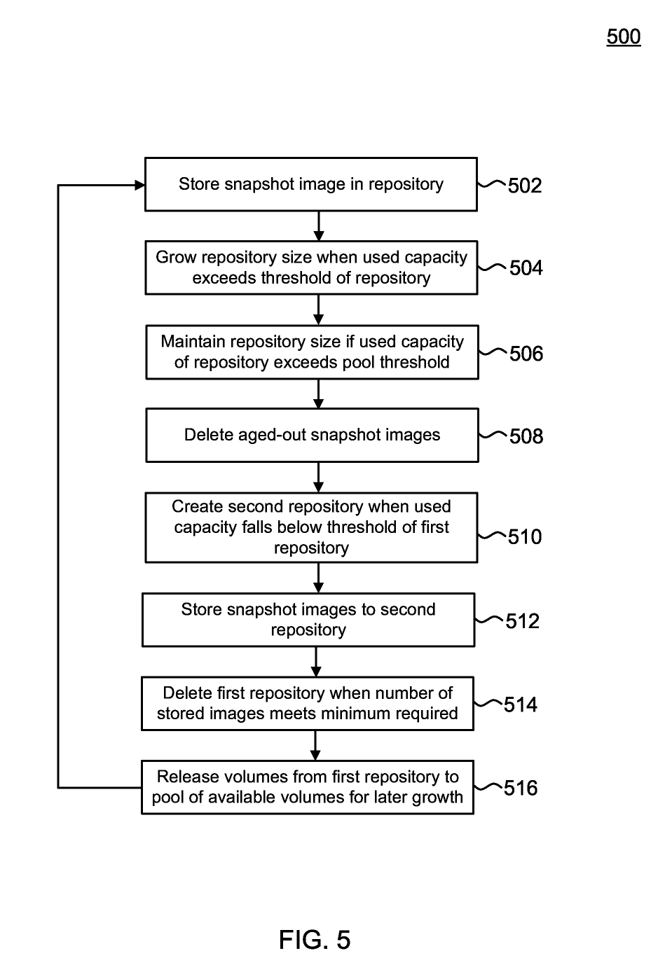

FIG. 5 is a flow diagram of a method 500 of providing an elastic snapshot repository according to aspects of the present disclosure. In an embodiment, the method 500 may be implemented by one or more processors of the server 114 executing computer-readable instructions to perform the functions described herein in cooperation with the storage controllers 108 of the storage system 102. It is understood that additional steps can be provided before, during, and after the steps of method 500, and that some of the steps described can be replaced or eliminated for other embodiments of the method 500.

At step 502, the server 114 causes the storage controller 108 to store a snapshot image in a snapshot repository of the storage system 102. For example, the snapshot image may be snapshot image 204 within snapshot repository 201 as described with respect to FIG. 2 above (or snapshot repository 301 of FIGS. 3, 4A, 4B, and 4C). For example, as part of step 502 the storage controller 108 may store a block of data from a base volume at a point in time in response to a write directed to that block of data (before the data is overwritten by the write). This may be stored as part of the snapshot image (e.g., the snapshot image being an image of data at points in time over a period of time).

At step 504, the server 114 causes the storage controller 108 to grow the snapshot repository 201's size in response to detecting that the snapshot repository 201's used capacity exceeds an upper threshold (e.g., in response to the server 114 issuing a CLI command requesting a status of the used capacity) with respect to the overall capacity of the snapshot repository. For example, as described above, the upper threshold may be a percentage of the used capacity versus the overall capacity of the snapshot repository (e.g. 75% as just one non-limiting example). The snapshot repository 201's used capacity may exceed the upper threshold, for example, where some particular snapshot images are larger than predicted due to an unexpectedly large write operation or series of writes in the corresponding time period.

The server 114 causes the storage controller 108 to grow the snapshot repository 201 by instructing the storage controller 108 to obtain an available volume 208 from the pool 206 illustrated in FIG. 2 and add the available volume 208 to the adjacent used volume 202 in the concat object of snapshot repository 201. Prior to actually instructing the storage controller 108 to grow the snapshot repository 201, and in addition to detecting the threshold being exceeded, the server 114 may also check that the snapshot repository 201 does not already have more than a certain number of volumes already (e.g., 16 volumes 202 as just one non-limiting example—as will be recognized, a larger or smaller value may alternatively be used). The server 114 may do so by sending a command to the storage controller 108 to report the number of volumes associated with the snapshot repository 201.

The server 114 may also issue a command to check a usage threshold of the available volumes 208 in the pool 206. For example, the usage threshold may be a minimum number of available volumes 208 remaining in the pool 206, or a maximum percentage of used capacity in the snapshot repository 201 versus the total available capacity of the available volumes 208 originally allocated (or now remaining) in the pool 206, to name a few examples. If these conditions are met, then the server 114 may continue with growing the snapshot repository 201.

After the snapshot repository 201 is grown, the server 114 may continue to cause the storage controller 108 to add new snapshot images to the snapshot repository 201 according to a schedule associated with the snapshot repository 201. During this time, the server 114 may at least periodically issue commands to check the used capacity of the snapshot repository 201. As new images are added, this may again place the grown snapshot repository 201 in a situation where its used capacity gets near to, or exceeds, the upper threshold discussed with respect to step 504. At step 506, the server 114 directs the storage controller 108 to maintain the size of the snapshot repository 201, despite the used capacity exceeding the upper threshold, in response to determining that growing the snapshot repository 201 again would cause the usage threshold to be exceeded (e.g., either causing the number of available volumes 208 in the pool 206 to drop below the minimum number or the overall percentage of used capacity versus total available capacity in the pool 206).

At step 508, the snapshot images 204 that have “aged out” are deleted—e.g., either by the passage of a set period of time or by newer snapshot images 204 that meet any minimum history requirement set by the user.

At step 510, the server 114 causes the storage controller 108 to create a second snapshot repository, for example snapshot repository 303 as illustrated in FIG. 4B, in addition to snapshot repository 301 of FIG. 4B. The server 114 instructs the storage controller 108 to create the second snapshot repository 303 in response to detecting that the used capacity of the snapshot repository 301 has fallen below a lower threshold with respect to the total capacity of the snapshot repository 301 (for example, based on a used capacity reported to the server 114). This lower threshold may be a percentage of the used capacity of the snapshot repository 301 with respect to the total capacity of the snapshot repository 301 or, alternatively, a minimum number of volumes storing active snapshot images 404 in FIG. 4B. The used capacity of the snapshot repository 301 may fall, for example, as older snapshot images “age out” (for example as described at step 508 above). This may be particularly true where older snapshot images that “age out” are ones which had unusually large amounts of data written.

At step 512, the server 114 continues to cause the storage controller 108 to store snapshot images, now to the second snapshot repository 303 instead of to the snapshot repository 301 for the same base volume, according to the active schedule associated with the second snapshot repository 303.

The storage controller 108 continues to store snapshot images to the second snapshot repository 303 under the direction of the server 114. During this time, the snapshot images stored with the snapshot repository 301 are maintained (either all kept or age out) until there is sufficient history at the second snapshot repository 303 to meet the minimum history requirements of the user. At step 514, once the minimum history requirement is met by the number of snapshot images stored with the second snapshot repository 303, the server 114 instructs the storage controller 108 to delete the first snapshot repository 301.

At step 516, in response to deletion of the first snapshot repository 301, the volumes associated with the first snapshot repository 301 are released to the pool 306, becoming available volumes 308 for dynamically growing the snapshot repository 303 or any other repositories that have access to the pool 306. According to embodiments of the present disclosure, method 500 may proceed back to step 502 and continue adding snapshot images to the snapshot repository, dynamically growing the snapshot repository where necessary, maintaining the size of the snapshot repository where necessary, and/or shrinking the size of the snapshot repository where appropriate.

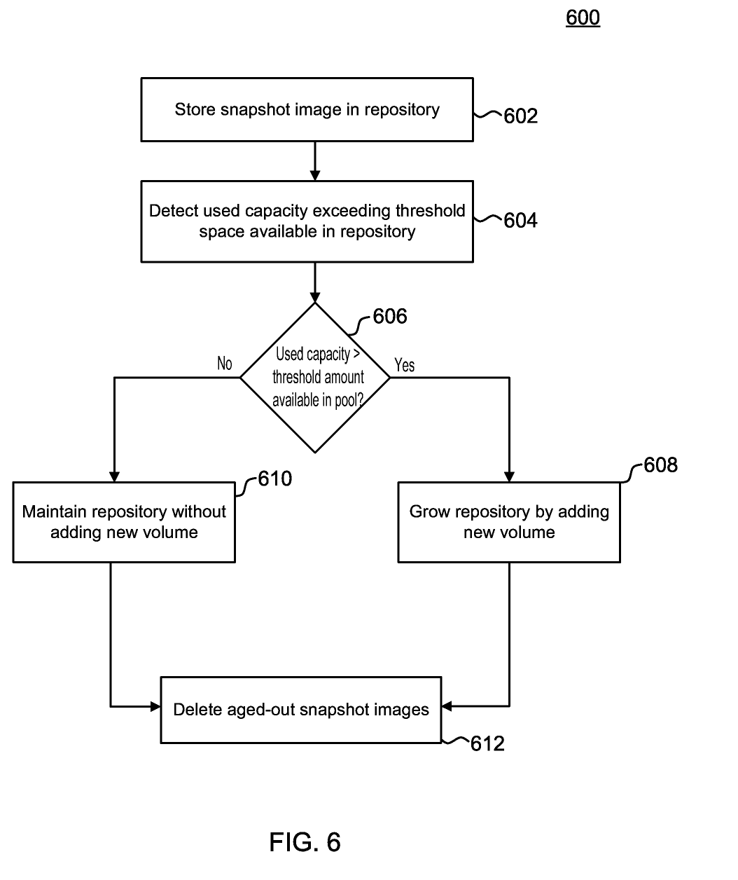

Turning now to FIG. 6, a flow diagram is illustrated of a method 600 of growing and maintaining an elastic snapshot repository according to aspects of the present disclosure. In an embodiment, the method 600 may be implemented by one or more processors of the server 114 executing computer-readable instructions to perform the functions described herein in cooperation with the storage controllers 108 of the storage system 102. It is understood that additional steps can be provided before, during, and after the steps of method 600, and that some of the steps described can be replaced or eliminated for other embodiments of the method 600.

At step 602, the server 114 directs the storage controller 108 to store a snapshot image in a snapshot repository, for example as described above with respect to step 502 of FIG. 5.

The server 114, according to a schedule associated with the snapshot repository, may periodically or continuously check the status (e.g., a used capacity) of the snapshot repository. At step 604, the server 114 detects that the used capacity of the snapshot repository (the capacity of the underlying volumes that have snapshot image data/metadata stored) exceeds a pre-determined (upper) threshold with respect to the overall capacity of the snapshot repository. The server 114 detects this in response to a reported used capacity returned to the server 114 in response to a prior command to report the capacity.

The method 600 then proceeds to decision block 606, where the server 114 determines whether the used capacity of the snapshot repository exceeds a usage threshold with respect to the available volumes in the pool of available volumes. For example, the server 114 may check whether a minimum number of available volumes 208 remain in the pool 206 either before or after growing the snapshot repository (e.g., by issuing a command to the storage system 102 to report the current number of available volumes 208). Alternatively (or in addition), the server 114 may check whether the percentage of used capacity in the snapshot repository 201 versus the total available capacity of the available volumes 208 originally allocated (or now remaining) in the pool 206 exceeds a maximum percentage amount. At decision block 606, the server 114 may also check that the snapshot repository 201 does not already have more than a certain number of volumes.

If, at decision block 606, it is determined that the usage threshold is met or exceeded, then the method 600 proceeds to step 608. At step 608, the server 114 maintains the size of the snapshot repository, despite the used capacity exceeding the upper threshold of the snapshot repository, in response to determining that growing the snapshot repository again would cause the usage threshold to be met or exceeded (e.g., either causing the number of available volumes 208 in the pool 206 to drop below the minimum number or the overall percentage of used capacity versus total available capacity in the pool 206).

If, instead, at decision block 606 it is determined that the usage threshold is not met or exceeded (and, where implemented, the snapshot repository does not already have more than a certain number of volumes), the method 600 proceeds to step 610. At step 610, the server 114 grows the snapshot repository by instructing the storage controller 108 to obtain an available volume from the pool and add the available volume to the adjacent used volume of the snapshot repository.

After growing the snapshot repository, the server 114 may continue to cause the storage controller 108 to add new snapshot images to the snapshot repository according to a schedule associated with the snapshot repository. The method 600 may proceed from either step 608 or step 610 to step 612. At step 612, in conjunction with the server 114 continuing to periodically add new snapshot images according to a schedule, the storage controller 108 correspondingly ages out older snapshot images that are no longer necessary in order to meet the minimum history requirements of the user.

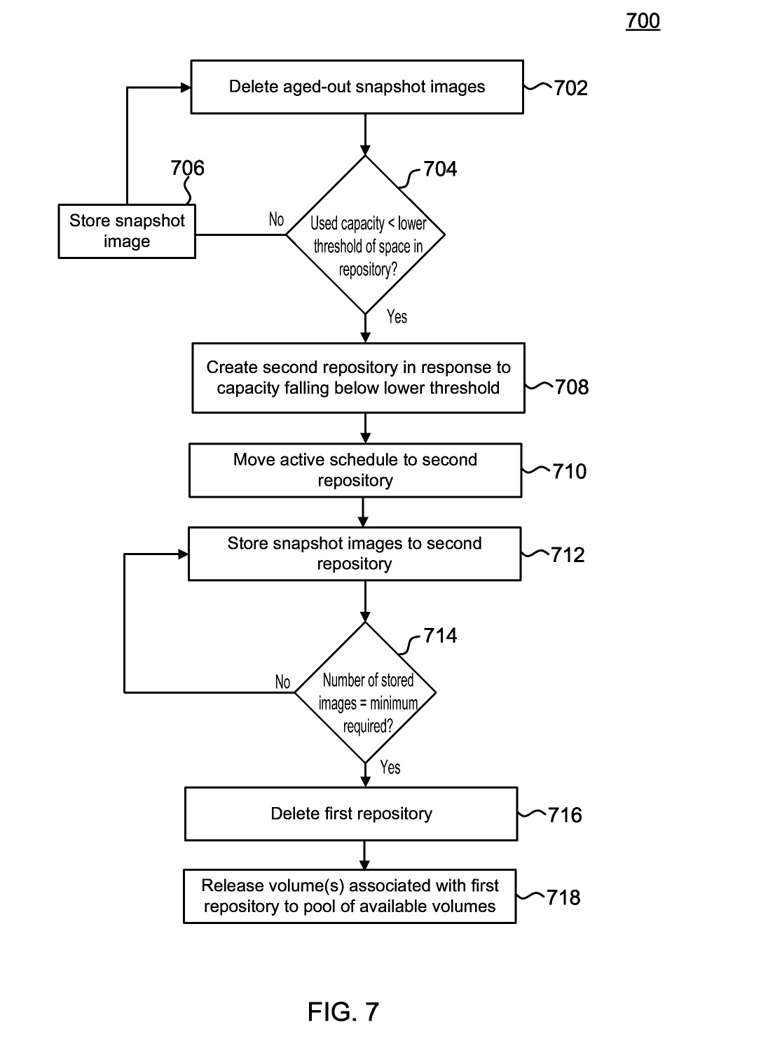

In addition to growing a snapshot repository, embodiments of the present disclosure also enable the dynamic shrinking of a snapshot repository, as illustrated in FIG. 7. FIG. 7 is a flow diagram of a method 700 of shrinking an elastic snapshot repository according to aspects of the present disclosure. In an embodiment, the method 700 may be implemented by one or more processors of the server 114 executing computer-readable instructions to perform the functions described herein in cooperation with the storage controllers 108 of the storage system 102. It is understood that additional steps can be provided before, during, and after the steps of method 700, and that some of the steps described can be replaced or eliminated for other embodiments of the method 700.

The method 700 may optionally begin at step 702 or at decision block 704. For example, in some embodiments the method 700 may begin at decision block 704 where the snapshot repository was originally created with more available storage space than necessary to store enough snapshot images of the corresponding base volume to meet the minimum history requirement imposed by the user. In that scenario, the method 700 may begin at decision block 704 because there are no snapshot images to age out.

Alternatively, the method 700 may begin at step 702 where one or more snapshot images have begun to age out, and therefore deleted from the snapshot repository, prior to a used capacity falling low enough to trigger the rest of the method 700.

At decision block 704, the server 114 determines whether the used capacity of the snapshot repository is less than a lower threshold with respect to the total capacity of the snapshot repository (e.g., based on a used capacity provided in response to a command sent from the server 114). This lower threshold may be a percentage of the used capacity with respect to the total capacity of the snapshot repository or, alternatively, a minimum number of volumes storing active snapshot images. If the used capacity has not fallen below the lower threshold, then the method 700 proceeds to step 706, where the method 700 continues to store snapshot images according to the pre-defined schedule associated with the snapshot repository (for example, schedule 410 associated with the snapshot repository 301 illustrated in FIG. 4B). The method 700 then continues back to step 702, where snapshot image(s) age out and are deleted, and again to decision block 704.

If at decision block 704 the server 114 determines that the used capacity has fallen below the lower threshold, then the method 700 proceeds to step 708.

At step 708, the server 114 creates (e.g., by issuing a command to the storage controller 108) a second snapshot repository 303 that is stacked with the still-existing first snapshot repository 301 (as illustrated in FIG. 4B) in response to determining that the used capacity has fallen below the lower threshold.

At step 710, the server 114 changes the active schedule to be the schedule 412 associated with the second snapshot repository 303. This may be done, for example, by activating the schedule 412 associated with the second snapshot repository 303 while also de-activating the schedule 410 associated with the first snapshot repository 301. Alternatively, the schedule 410 may be deleted.

As a result, at step 712 only the schedule associated with the second, new snapshot repository is active and therefore subsequent snapshot images for the same base volume are stored with the second snapshot repository 303 instead of the first snapshot repository 301. During this time, the snapshot images stored with the snapshot repository 301 are maintained (either all kept or age out) until there is sufficient history at the second snapshot repository 303 to meet the minimum history requirements of the user.

At decision block 714, the server 114 checks whether the number of stored images in the second snapshot repository 303 meets the specified minimum history requirement (e.g., x number of snapshot images have been stored to the new snapshot repository where a minimum number of x snapshot images is required according to a history requirement). The server 114 may do so by issuing a command to the storage system 102 to report the number of snapshot images currently stored, or alternatively by checking a locally-maintained count. If the server 114 determines at decision block 714 that the number of images does not yet meet the minimum history requirement, the method 700 returns to step 712 where the server 114 continues to cooperate with the storage controller 108 to store snapshot images and check until the minimum history has been met.

If the number of snapshot images meets the minimum history requirement, then the method 700 proceeds to step 716. At step 716, once the minimum history requirement is met by the number of snapshot images stored with the second snapshot repository 303, the first snapshot repository 301 is deleted.

At step 718, in response to deletion of the first snapshot repository 301, the volumes associated with the first snapshot repository 301 are released to the pool 306, becoming available volumes 308 for dynamically growing the snapshot repository 303 or any other snapshot repositories that have access to the pool 306. After the snapshot repository has thereby dynamically shrunk, according to embodiments of the present disclosure the snapshot repository may continue growing and/or shrinking as appropriate and as described with respect to the various figures above.

The present embodiments can take the form of an entirely hardware embodiment, an entirely software embodiment, or an embodiment containing both hardware and software elements. In that regard, in some embodiments, the computing system is programmable and is programmed to execute processes including those associated with providing an elastic snapshot repository such as the processes of methods 400, 500, and/or 600 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and Random Access Memory (RAM).

Thus, the present disclosure provides system, methods, and computer-readable media for the elastic growth and shrinking of a snapshot repository. In some embodiments, the method includes storing a snapshot image of a base volume to a first repository volume in a snapshot repository, the snapshot repository being configured to maintain a minimum number of snapshot images according to a pre-determined history amount; detecting, in response to storage of the snapshot image, that a used capacity of the snapshot repository has exceeded an upper threshold of available space in the snapshot repository; and concatenating, in response to the detecting, a second repository volume from a pool of available repository volumes to the first repository volume in the snapshot repository.

In further embodiments, the computing device includes a memory containing machine readable medium comprising machine executable code having stored thereon instructions for providing an elastic snapshot repository; and a processor coupled to the memory. The processor is configured to execute the machine executable code to store a snapshot image of a base volume to a first repository volume in the snapshot repository, the snapshot repository being configured to maintain a minimum number of snapshot images according to a pre-determined history amount; detect, in response to storage of the snapshot image, that a used capacity of the snapshot repository has exceeded an upper threshold of available space in the snapshot repository; and concatenate, in response to the detection, a second repository volume from a pool of available repository volumes to the first repository volume in the snapshot repository.

In yet further embodiments a non-transitory machine readable medium having stored thereon instructions for performing a method of providing an elastic snapshot repository comprises machine executable code. When executed by at least one machine, the code causes the machine to store a snapshot image of a base volume to a first repository volume in the snapshot repository according to a schedule associated with the snapshot repository, the snapshot repository being configured to maintain a minimum number of snapshot images according to a pre-determined history amount; detect, in response to storage of the snapshot image, that a used capacity of the snapshot repository has exceeded an upper threshold of available space in the snapshot repository; and concatenate, in response to the detection, a second repository volume from a pool of available repository volumes to the first repository volume in the snapshot repository.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
storing a snapshot image of a base volume to a first repository volume in a snapshot repository, the snapshot repository being configured to maintain a minimum number of snapshot images according to a pre-determined history amount;
detecting, in response to storage of the snapshot image, that a used capacity of the snapshot repository has exceeded an upper threshold of available space in the snapshot repository; and
concatenating, in response to the detecting, a second repository volume from a pool of available repository volumes to the first repository volume in the snapshot repository.

2. The method of claim 1, further comprising:
pre-allocating each repository volume in the pool of available repository volumes prior to assignment to any snapshot repository.

3. The method of claim 1, further comprising:
storing a second snapshot image of the base volume to the snapshot repository;
detecting, in response to the storing the second snapshot image, that the used capacity of the snapshot repository has exceeded the upper threshold of the available space in the snapshot repository;
determining that the used capacity exceeds a threshold of available space in the pool of available repository volumes; and
maintaining the snapshot repository without adding a third repository volume from the pool of available repository volumes in response to the determining.

4. The method of claim 1, further comprising:
storing a third snapshot image of the base volume to the snapshot repository;
determining that storage of the third snapshot image results in the snapshot repository having more snapshot images than the minimum number of snapshot images according to the pre-determined history amount; and
deleting, in response to the determining, one or more older snapshot images from the snapshot repository.

5. The method of claim 4, further comprising:
detecting, in response to the deleting, that the used capacity of the snapshot repository is below a lower threshold of the available space in the snapshot repository;
creating, in response to the detecting, a new snapshot repository with a new schedule; and
setting a schedule associated with the snapshot repository into an inactive state and the new schedule associated with the new snapshot repository into an active state.

6. The method of claim 5, further comprising:
storing one or more new snapshot images of the base volume to the new snapshot repository according to the new schedule while maintaining the snapshot repository;
determining when a number of the one or more new snapshot images stored to the new snapshot repository exceeds the minimum number of snapshot images; and
deleting the snapshot repository in response to the determining the number of the one or more new snapshot images exceeds the minimum number.

7. The method of claim 6, further comprising:
releasing repository volumes associated with the deleted snapshot repository to the pool of available repository volumes in response to the deleting the snapshot repository.

8. A computing device comprising:
a memory containing machine readable medium comprising machine executable code having stored thereon instructions for performing a method of providing an elastic snapshot repository; and
a processor coupled to the memory, the processor configured to execute the machine executable code to:
store a snapshot image of a base volume to a first repository volume in the snapshot repository, the snapshot repository being configured to maintain a minimum number of snapshot images according to a pre-determined history amount;
detect, in response to storage of the snapshot image, that a used capacity of the snapshot repository has exceeded an upper threshold of available space in the snapshot repository; and
concatenate, in response to the detection, a second repository volume from a pool of available repository volumes to the first repository volume in the snapshot repository.

9. The computing device of claim 8, wherein the processor is further configured to execute the machine executable code to:
pre-allocate each repository volume in the pool of available repository volumes prior to assignment to any snapshot repository.

10. The computing device of claim 8, wherein the processor is further configured to execute the machine executable code to:
store a second snapshot image of the base volume to the snapshot repository;
detect, in response to the storage of the second snapshot image, that the used capacity of the snapshot repository has exceeded the upper threshold of the available space in the snapshot repository;
determine that the used capacity exceeds a threshold of available space in the pool of available repository volumes; and
maintain the snapshot repository without adding a third repository volume from the pool of available repository volumes in response to the determination.

11. The computing device of claim 8, wherein the processor is further configured to execute the machine executable code to:
store a third snapshot image of the base volume to the snapshot repository;
determine that storage of the third snapshot image results in the snapshot repository having more snapshot images than the minimum number of snapshot images according to the pre-determined history amount; and
delete, in response to the determination, one or more older snapshot images from the snapshot repository.

12. The computing device of claim 11, wherein the processor is further configured to execute the machine executable code to:
detect, in response to the deletion, that the used capacity of the snapshot repository is below a lower threshold of the available space in the snapshot repository;
create, in response to the detection, a new snapshot repository with a new schedule; and
set a schedule associated with the snapshot repository into an inactive state and the new schedule associated with the new snapshot repository into an active state.

13. The computing device of claim 12, wherein the processor is further configured to execute the machine executable code to:
store one or more new snapshot images of the base volume to the new snapshot repository according to the new schedule while maintaining the snapshot repository;
determine when a number of the one or more new snapshot images stored to the new snapshot repository exceeds the minimum number of snapshot images; and
delete the snapshot repository in response to the determination that the number of the one or more new snapshot images exceeds the minimum number.

14. The computing device of claim 13, wherein the processor is further configured to execute the machine executable code to:
release repository volumes associated with the deleted snapshot repository to the pool of available repository volumes in response to the deletion of the snapshot repository.

15. A non-transitory machine readable medium having stored thereon instructions for performing a method of providing an elastic snapshot repository, comprising machine executable code which when executed by at least one machine, causes the machine to:
store a snapshot image of a base volume to a first repository volume in the snapshot repository, the snapshot repository being configured to maintain a minimum number of snapshot images according to a pre-determined history amount;
detect, in response to storage of the snapshot image, that a used capacity of the snapshot repository has exceeded an upper threshold of available space in the snapshot repository; and
concatenate, in response to the detection, a second repository volume from a pool of available repository volumes to the first repository volume in the snapshot repository.

16. The non-transitory machine readable medium of claim 15, comprising further machine executable code that causes the machine to:
pre-allocate each repository volume in the pool of available repository volumes prior to assignment to any snapshot repository.

17. The non-transitory machine readable medium of claim 15, comprising further machine executable code that causes the machine to:
store a second snapshot image of the base volume to the snapshot repository;
detect, in response to the storage of the second snapshot image, that the used capacity of the snapshot repository has exceeded the upper threshold of the available space in the snapshot repository;
determine that the used capacity exceeds a threshold of available space in the pool of available repository volumes; and
maintain the snapshot repository without adding a third repository volume from the pool of available repository volumes in response to the determination.

18. The non-transitory machine readable medium of claim 15, comprising further machine executable code that causes the machine to:
store a third snapshot image of the base volume to the snapshot repository;
determine that storage of the third snapshot image results in the snapshot repository having more snapshot images than the minimum number of snapshot images according to the pre-determined history amount; and
delete, in response to the determination, one or more older snapshot images from the snapshot repository.

19. The non-transitory machine readable medium of claim 18, comprising further machine executable code that causes the machine to:
detect, in response to the deletion, that the used capacity of the snapshot repository is below a lower threshold of the available space in the snapshot repository;
create, in response to the detection, a new snapshot repository with a new schedule; and
set a schedule associated with the snapshot repository into an inactive state and the new schedule associated with the new snapshot repository into an active state.

20. The non-transitory machine readable medium of claim 19, comprising further machine executable code that causes the machine to:
store one or more new snapshot images of the base volume to the new snapshot repository according to the new schedule while maintaining the snapshot repository;
determine when a number of the one or more new snapshot images stored to the new snapshot repository exceeds the minimum number of snapshot images;
delete the snapshot repository in response to the determination that the number of the one or more new snapshot images exceeds the minimum number and release repository volumes associated with the deleted snapshot repository to the pool of available repository volumes in response to the deletion of the snapshot repository.
